(19) United States
(12) Patent Application Publication
(10) Pub. No.: US 2012/0304819 A1
(43) Pub. Date: Dec. 6, 2012

(54) INERTIAL TRACTION DEVICE

(76) Inventor: Osvaldo Falesiedi, San Benigno Canavese (IT)

(21) Appl. No.: 13/261,365

(22) PCT Filed: Jan. 13, 2011
(86) PCT No.: PCT/IB11/50150

§ 371 Date: Jul. 13, 2012

(30) Foreign Application Priority Data
Jan. 14, 2010 (EP) 10425008.9

(51) Int. Cl. B63H 19/00; F03G 3/00

(52) U.S. Cl. 74/84 R; 74/88

(57) ABSTRACT

Impulse traction device for moving a body (M) resting on a bearing surface (S), characterized in that it comprises impulse means generating opposed alternate impulses (Ivo+, Ivo−) according to an impulse direction (I), wherein said impulse di-reaction (I) is oblique with respect to said bearing surface (S),

### APPLICATION FIELD OF THE INVENTION

The present invention relates to the field of inertial traction devices, in particular for ground vehicles.

### DESCRIPTION OF THE PRIOR ART

Impulse traction systems, wherein at least a mass oscillates forward and backward, parallel to the ground, are known in the art.

Such systems are based on that at least a bearing surface has an not homogeneous friction coefficient along the direction of oscillation of the masses.

This results in a different friction force according to the two opposite ways of said direction of oscillation. Thus, the bearing surface runs forward but not backward.

Examples of traction systems based on such principle are disclosed in the following documents: DE2405343, DE2101375, U.S. Pat. No. 3,196,580.

Such solution is more advantageous if such friction coefficient is adjustable. This may be realized by means of adjustable nails in terms of inclination.

By inverting the inclination of the nails, it is also possible to invert the direction of the motion.

This, however, implies the presence, for example, of hinges and movable parts etc., which make the traction system delicate and difficult to be used in industry.

For example, such solutions are not suitable for marine applications, where the presence of hinged adjustable nails is not suitable for the vegetation of the sea which sticks to the parts immersed in water.

Moreover, the effects of salted water on such elements may be disastrous.

On the other hand, a hull shaped in order to generate a lower resistance for forward motion than for backward motion, implies a difficulty in inverting the motion of the vehicle.

### SUMMARY OF THE INVENTION

Therefore the aim of the present invention is to overcome all the aforementioned drawbacks and to provide a versatile inertial traction system, applicable in any condition.

The subject of the present invention is an inertial traction device according to claim 1.

Advantageously, such device is particularly applied in the nautical field, being it able to move a ship according to any direction, even transversely- to a respective longitudinal development.

The object of the present invention is in particular a vehicle comprising the present traction device, as described more fully in the claims, which are an integral part of this description.

### BRIEF DESCRIPTION OF THE FIGURES

Further purposes and advantages of the present invention will become clear from the following detailed description of preferred embodiments and from the drawings that are attached hereto that are merely illustrative and not limitative, in which:

FIG. 1 shows a composition of a first pair of impulsive forces applied to a body by the traction device,

FIG. 2 shows a system of forces acting on the body after the application of the forces of FIG. 1,

FIG. 3 shows a composition of a second pair of impulsive forces applied to the body by the traction device,

FIG. 4 shows a system of forces acting on the body after the application of the forces of FIG. 3,

FIG. 5 shows the respective vector composition of the first and second pair of impulsive forces shown in the previous figures.

In the figures the same reference numbers and letters identify the same elements or components.

### DETAILED DESCRIPTION OF PREFERRED EMBODIMENTS OF THE INVENTION

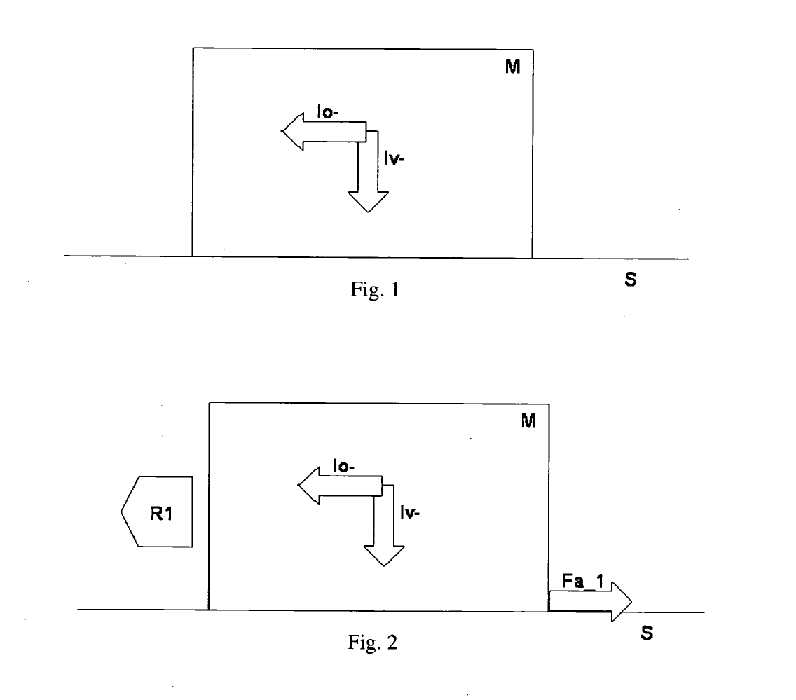

According to the present invention, and with reference to FIG. 1, two forces are applied to the center of gravity of a body M resting on a bearing surface S: the first Iv− is a vertical force applied downwards, the second Io− is a horizontal force applied leftwards.

Thus, the first force tends to compress the body against the bearing surface, while the second force tends to move it leftwards.

The resting of the body on the bearing surface develops a friction coefficient μ.

The system of applied forces generates a friction force Fa_1=μ(Mg+(Iv−)) oriented in an opposite way with respect to Io−, namely rightwards, as shown in FIG. 2.

If the modulus of the second force Io− does not exceed the modulus of such friction force Fa_1, then the body M does not move.

On the contrary, if the modulus of the second force Io− exceeds the modulus of the friction force Fa_1, the body M moves leftwards, because of the resultant of the forces R1.

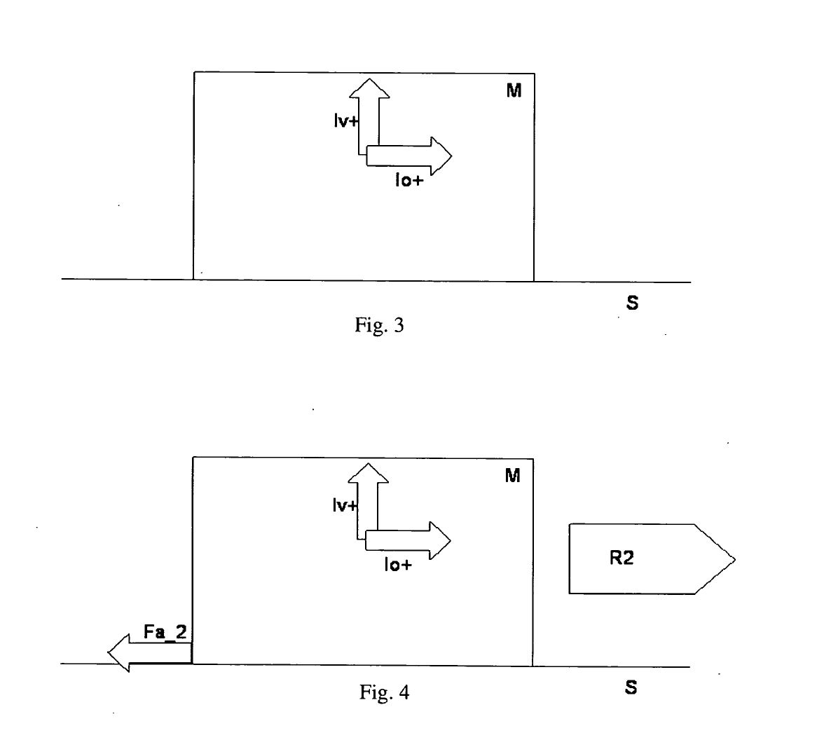

With reference to FIG. 3, further two forces are applied to the body M. This time a third vertical force Iv+ is applied upwards and a fourth horizontal force Io+ is applied rightwards.

The friction force Fa_2 this time is shown in FIG. 4 and results from Fa_2=·(Mg−(Iv+)).

It is evident that the friction force Fa_2 developed in the configuration of FIG. 4 is weaker than the friction force Fa_1 developed in FIG. 2. This implies that the body tends to progressively move rightwards, under the action of the resultant R2>R1, although the friction coefficient μ is homogeneous, namely it is constant in any direction lying on the bearing surface S.

Thus according to the present invention, an object is moved by applying pairs of impulsive forces perpendicular between each other, of which one is perpendicular to the bearing surface and the other is parallel to the bearing surface. In particular, a forward impulse Io+ is associated to an upward impulse Iv+.

As it will be illustrated in the following, also the respective resultants may be applied in the same way as between Io−/Iv− and Io+/Iv+.

Such impulse associations may be obtained by means of oscillating or rotating masses, etc.

Such result is absolutely advantageous in the nautical field, since such masses may be installed inside the hull without requiring any modification of the surface of the vehicle hull.

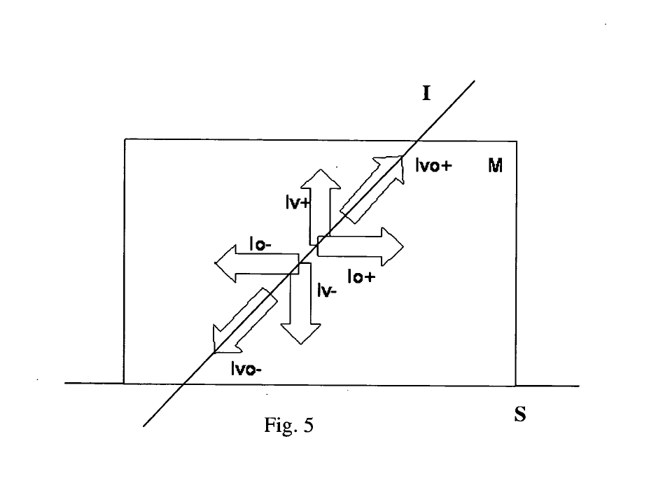

By composing Iv− with Io− and Iv+ with Io+ in a vector, Ivo− and Ivo+ are obtained, as shown in FIG. 5, which are parallel and counteracting between each other, according to an oblique direction with respect to the bearing surface, namely according to a so-called direction of impulse I.

According to a preferred embodiment of the invention, alternate impulses Ivo- and Ivo+ are obliquely developed with respect to the bearing surface S.

Thus it is clear that the technical effect may be obtained by summing the vectors of two impulse pairs Io−/Iv− and Io+/iv+ or by only two impulses oriented according to I.

A traction system generating such impulses is efficient in any real system, namely in any system wherein a friction coefficient is present between the body M and the bearing surface S.

According to a preferred embodiment, a single oscillating mass is used to generate impulses intended to move a body. Advantageously, by changing the inclination of the impulse direction I of the mass it is possible to amplify or to dampen the effect.

As an alternative, instead of an oscillating mass, eccentric masses counter-rotating between each other may be used, for example a pair of synchronous counter-rotating masses having a phase equal to zero with respect to said impulse direction I, which projects a forward movement direction on the bearing surface S.

Such configuration determines that their contribution, in terms of centrifugal forces, is summed and always gives a resultant vector equal to zero, except that along said impulse direction I.

Other alternative embodiments can be realized by the person skilled in the art.

Advantageously, the method and the device described above, may adapt to such situations where it is not possible to vary the friction coefficient of a bearing surface, of a body, of a vehicle, as in the case of ships, etc.

Thus, by appropriately dimensioning a mass system which determine direct impulses according to Ivo+ and Ivo−, it is possible to induce a translational movement in any body. Moreover, electric or hydraulic or pneumatic actuators may be associated to the impulse system, in order to variate the orientation of the impulse direction I in the space, for example in order to move the body or the ship according to a lateral direction, especially during docking operations, or to a forward or backward direction according to the needs.

The traction device may be advantageously driven by means of a joystick, which controls orientation and inclination means of the inertial device.

According to another aspect of the invention, the lower surface of the body may be provided with a not homogeneous friction coefficient, which superimposes to the technical effect described above, and amplifies the friction force in a direction with respect to the opposite direction.

From the description set forth above it will be possible for the person skilled in the art to embody the invention with no need of describing further construction details.

The elements and the characteristics described in the different preferred embodiments may be combined without departing from the scope of the present invention.

1-6. (canceled)

7. Impulse traction device for moving a body resting on a bearing surface comprising impulse means generating opposed alternate impulses according to an impulse direction, wherein said impulse direction is oblique with respect to said bearing surface.

8. Device according to claim 1, further comprising first control means of the orientation of said impulse means.

9. Device according to claim 1, further comprising second adjustment means of an inclination (tilt) of said impulse direction in a plane perpendicular to said bearing surface.

10. Device according to claim 2, further comprising second adjustment means of an inclination (tilt) of said impulse direction in a plane perpendicular to said bearing surface.

11. Nautical vehicle comprising a device according to claim 1.
